(19) United States
(12) Patent Application Publication
(10) Pub. No.: US 2013/0071531 A1
(43) Pub. Date: Mar. 21, 2013

(54) MOBILE MUFFIN CONTAINER

(71) Applicants: Roni DAGAN, Netanya (IL); Noa MOYAL, Netanya (IL); Michael LIBRUS, Netanya (IL)

(72) Inventors: Roni DAGAN, Netanya (IL); Noa MOYAL, Netanya (IL); Michael LIBRUS, Netanya (IL)

(73) Assignee: RL INDUSTRY COMPANY LTD., Ningbo (CN)

(21) Appl. No.: 13/235,383

(22) Filed: Sep. 18, 2011

(51) Int. Cl. B65D 51/04; B65D 81/00; A21D 13/08

(52) U.S. Cl. 426/389; 426/394; 220/810

(57) ABSTRACT

It is disclosed a container for storing muffins and for their serving. The container includes a bottom, a cover attachable to the bottom, and doors connected to the cover. In a closed state, the door defines together with the bottom and with the cover a sealed compartment for storing the muffins, which are disposed in dishes. In an opened state, most of the stored cakes are accessible for being taken out of the compartment. The dishes have several cake concavities of substantially uniform shape. The bottom may be a baking dish of six or more concavities. The cover includes a handle for carrying the container. The cover is locked to the bottom, and the door is locked to the cover. The container may have an oval or round shape. In a round container, the door is slidably connected to the cover.

### BACKGROUND OF THE INVENTION

1. Field of the Invention

The invention is in the field of food storage, and especially deals with a mobile muffin container having doors for serving muffins without removal of a cover.

2. Description of Related Art

Muffins and cupcakes are used in a popular way to prepare and serve a cake at home and outside home. Being a personal size cake, muffins are ready to serve for immediate eating, saving the need to cut a large cake in equal pieces in order to serve them. In special, consuming muffins is a practical way to have a cake in a picnic, for a travel, etc. After baking, muffins are kept in a closed container or box, such as to prevent fast drying and preserve the freshness of that relatively humid cake.

Sometimes, the structure of the box or container makes it quite difficult to open the container for serving the muffins. Quite often, one would like to take out only one or two muffins and would like to do it in a reduced effort. Thus, it is an objective of the current invention to have a mobile container with a convenient way to take muffins out of the container.

### BRIEF SUMMARY OF THE INVENTION

It is disclosed according to some preferred embodiments of the current invention, a container for storing cakes and for serving the cakes. The container includes a bottom, a cover attachable to the bottom, and one or two doors connected to the cover. In a closed state, the door defines together with the bottom and with the cover a sealed compartment for storing the cakes, which are disposed in dishes. The dishes are compatible with the sealed compartment and have sites for receiving the cakes. In an opened state, most of the stored cakes are accessible for being taken out of the compartment. The cakes are ready to be served for eating.

Preferably, the dishes have a plurality of concavities of substantially uniform shape for receiving the cakes.

In one embodiment, the bottom is a baking dish having concavities for shaping cakes in a desired shape. Preferably, there are at least six such concavities.

In some embodiments, the cover includes a handle for carrying the container.

In some embodiments, the container is adapted for storing muffins without substantial drying for a duration of at least three days after baking, under room temperature in the range of 0-100° F. and room humidity in the range of 25-100%.

In some embodiments, the cover is lockable to the bottom, and the door is lockable to the cover.

In some embodiments, an horizontal cross-section of the container has a substantially oval boundary. Preferably, the door is pivotally connected to the cover.

In some embodiments, an horizontal cross-section of the container has a substantially circular boundary.

In some embodiments, the door is slidably connected to the cover.

It is disclosed according to some preferred embodiments of the current invention, a method for assembling and using a container for storing cakes and for serving them. The method includes providing the parts of a container, a bottom, a cover attachable to the bottom, and doors connectable to the cover. The method also includes disposing on the bottom dishes having several sites for receiving cakes, attaching the cover to the bottom, closing the doors such as to define with the bottom and with the cover a sealed compartment for storing the cakes, and opening a door such as to enable serving most of the stored cakes.

In some embodiments, the method further includes a step of locking the cover to the bottom, and locking the door to the cover.

In some embodiments, the method includes a step of sliding the door for opening.

### BRIEF DESCRIPTION OF THE DRAWINGS

The subject matter regarded as the invention is particularly pointed out and distinctly claimed in the concluding portion of the specification. The invention, however, both as to system organization and method of operation, together with features and advantages thereof, may best be understood by reference to the following detailed description when read with the accompanied drawings in which:

FIG. 1 illustrates a plurality of muffins in a baking paper cups.

FIG. 2a is an isometric view of an oval muffin container having two doors and a handle in a closed state.

FIG. 2b shows the oval muffin container in an opened state.

FIG. 2c is a isometric bottom view of the door.

FIG. 3a is an isometric view of the cover of the oval muffin container.

FIG. 3b and FIG. 3c are isometric views from opposite sides of a door locker.

FIG. 4a is a wide side view of an open muffin container having a baking dish as a bottom.

FIG. 4b is a narrow side view of the open muffin container.

FIG. 4c is an exploding view of the oval muffin container showing a serving muffin dish resting on a baking muffin dish which is used as a container bottom.

FIG. 5a is an isometric view of a round muffin container having a sliding door in an opened state.

FIG. 5b is an isometric upper view of the round muffin container in a closed state.

FIG. 5c is an isometric bottom view of the round muffin container in a closed state.

FIG. 6 is a rear upper view of the cover of the round muffin container.

FIG. 7a shows a bottom of the round muffin container.

FIG. 7b is an enlargement of an edge part of the bottom shown in FIG. 7a.

FIG. 8a is a rear upper isometric view of the sliding door of the round muffin container.

FIG. 8b is an upper view of a closed round muffin container.

FIG. 8c is a sectional view of the closed round muffin container along section A-A.

FIG. 8d is an enlarged sectional view showing the engagement of the container cover with the container bottom.

FIG. 8e is an enlarged sectional view showing the engagement of the sliding door with the container bottom.

FIG. 9 is a flow chart of a method for using an oval muffin container.

FIG. 10 is a flow chart of a method for using a round muffin container.

### DETAILED DESCRIPTION OF THE INVENTION

The present invention will now be described in terms of specific example embodiments. It is to be understood that the invention is not limited to the example embodiments disclosed. It should also be understood that not every feature of the methods and systems handling the described container is necessary to implement the invention as claimed in any particular one of the appended claims. Various elements and features of devices are described to fully enable the invention. It should also be understood that throughout this disclosure, where a method is shown or described, the steps of the method may be performed in any order or simultaneously, unless it is clear from the context that one step depends on another being performed first.

Before explaining several embodiments of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

Unless otherwise defined, all technical and scientific terms used herein have the same meaning as commonly understood by one of ordinary skill in the art to which this invention belongs. The systems, methods, and examples provided herein are illustrative only and not intended to be limiting.

In the description and claims of the present application, each of the verbs “comprise”, “include” and “have”, and conjugates thereof, are used to indicate that the object or objects of the verb are not necessarily a complete listing of members, components, elements or parts of the subject or subjects of the verb.

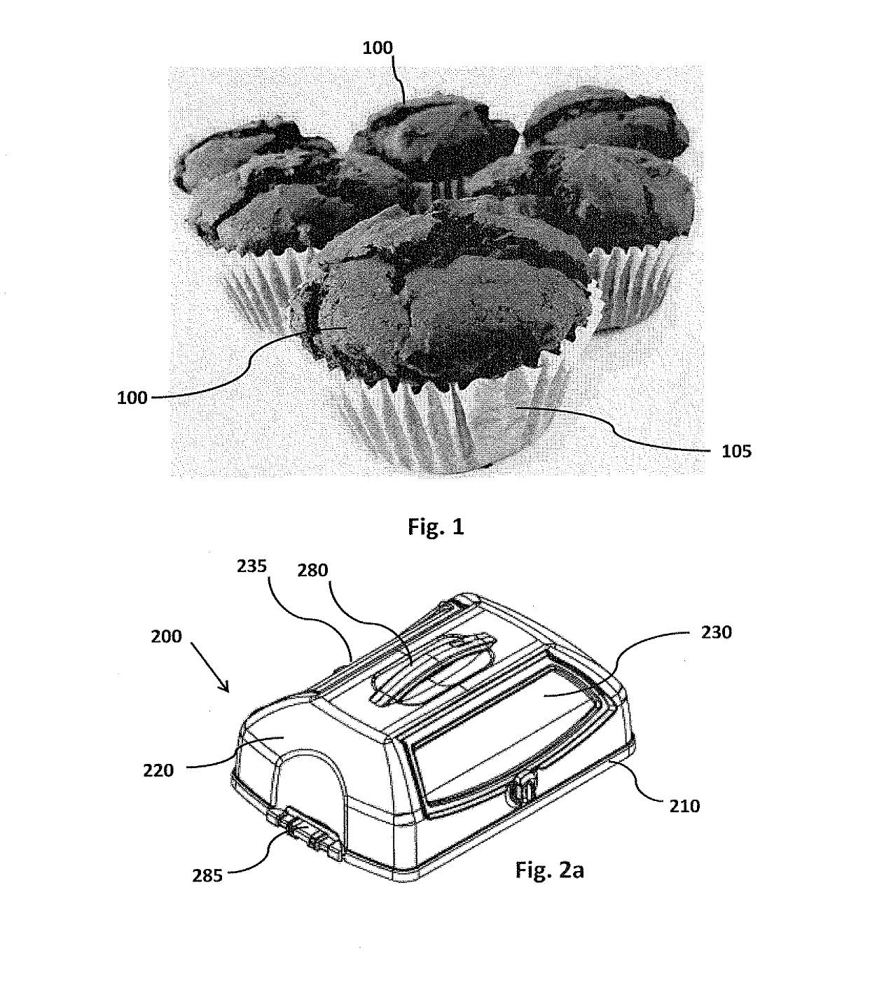

Muffins and cupcakes are used popularly for preparing and serving a cake at home and outside home. Being a personal size cake, muffins are ready to serve for immediate eating, saving the need to cut a large cake into small pieces in order to serve them. In special, muffins are used in a practical way to take a cake to a picnic, for a travel, a garden party, etc. FIG. 1 shows several muffins 100, each in an individual paper cup 105, which presumably had been used in baking muffins 100. After baking, muffins 100 are kept in a closed container, such as to prevent fast drying and preserve the freshness of a relatively humid cake. In some embodiments, the container is adapted for storing muffins without substantial drying for a duration of at least three days or five after baking, under room temperature in the range of 0-100° F. and room humidity in the range of 25-100%.

Also, in a container or box, the muffins are kept away of ants, insects, etc. In the following, two container embodiments according to the current invention are described on a way of example.

### An Oval Container Embodiment

### FIGS. 1-4

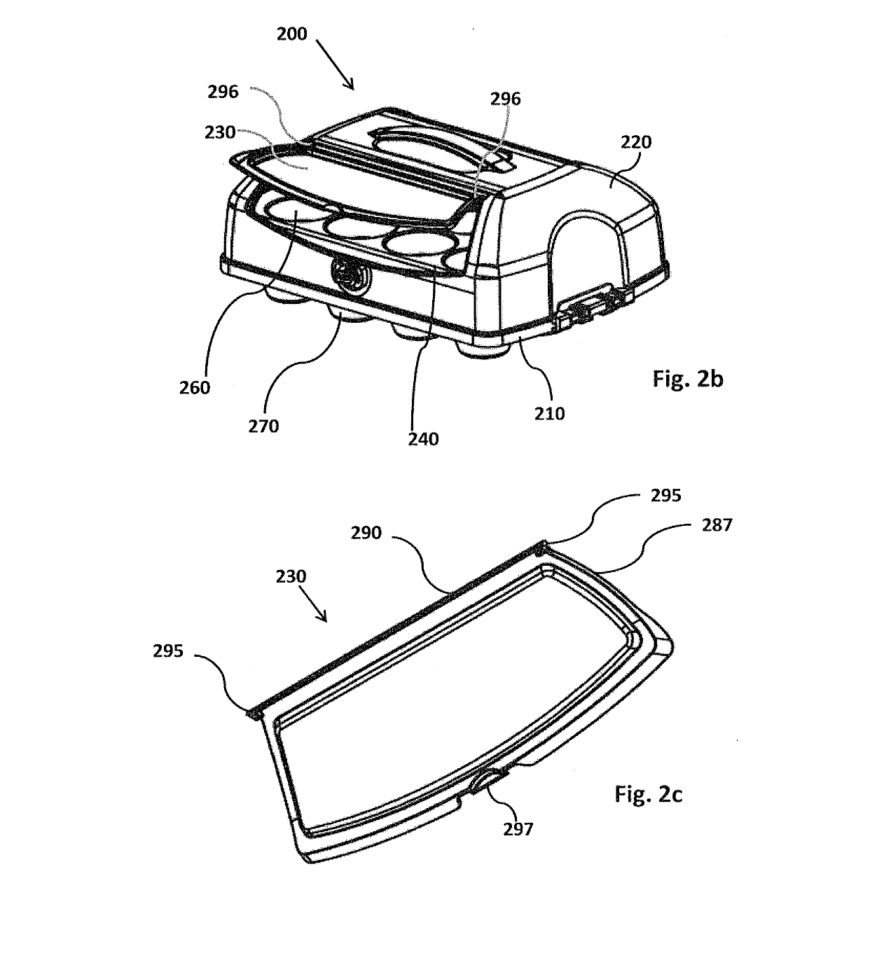

An oval container 200 is shown in FIGS. 2a and 2b in a closed state and in an opened state, respectively. Container 200 is designed for storing muffins or cupcakes, for carrying them from one place to another place conveniently, and for serving them. Container 200 includes a bottom 210, a cover 220 attached to bottom 210, and two doors 230 and 235 connected to cover 220. In the closed state, doors 230 define with bottom 210 and with cover 230 a sealed compartment for storing cupcakes 100 in dish 240 and in bottom dish 210. Dishes 240 and 210 are compatible with the sealed compartment and have sites or concavities 260 and 270, respectively, for receiving the cupcakes. In the opened state of FIG. 2b, cupcakes 100, stored in the side of the container close to opened door 230, are accessible for being taken out of the compartment. Cupcakes 100 stored in the other side are accessible for serving or taking out once door 235 is opened.

The horizontal cross-sections of container 200 have a substantially oval boundary. Door 230 is pivotally connected to cover 220 as shown in FIG. 2b. In a perspective bottom view of FIG. 2c, door 230 is shown to have a relatively thick frame 287, and a rod axis 290 is fastened to frame 287. Rod axis 290 has ends 295 for inserting in compatible cavities 296 of door 230, such as to allow pivotal opening and closing motion. The pivotal motion may be made frictional to such an extent that door 230 is kept in an opened state for a while. Also, keeping door 230 opened may be achieved in other ways known in the art. The thinner internal part of door 230 may be transparent or semi-transparent for exhibiting muffins 100 to potential consumers. Also, whole cover 220 may be transparent to some extent while having certain color.

A handle 280 is attached to cover 220 allowing a user to carry container 200 from one place to another, whereas two locking mechanism 285 lock cover 220 to bottom 210, such that cover 220 is kept connected to bottom 210 despite the displacement motion and the weight of the dishes and cupcakes. Preferably, the structure of the container, especially lockers 285 and handle 280, withstand a weight of at list 800 gr which includes dishes 210 and 260 and cupcakes 100. More preferably, the allowed weight is 1.5 kg or even 2.5 kg.

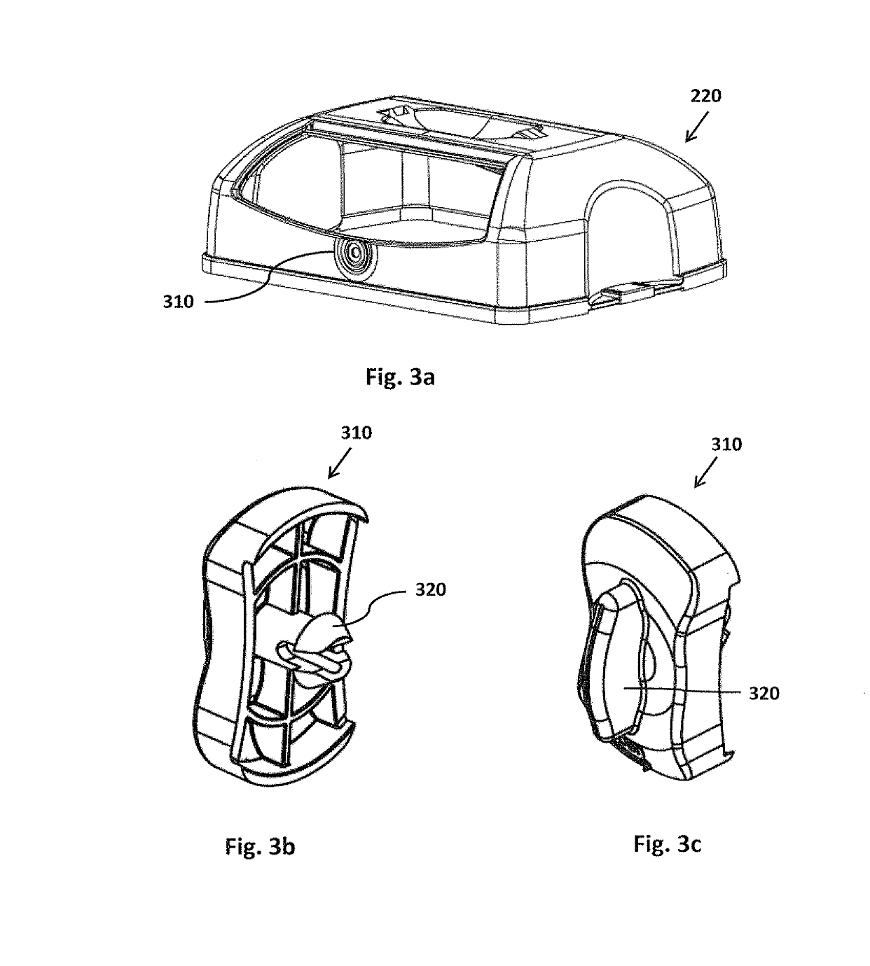

Door 230 has a locking part 297 to allow locking of door 230 to cover 220. To that aim, cover 220 has two lockers 310, shown in FIGS. 3a, 3b and 3c. Lockers 310 may be rotated between two positions. In a fully clockwise position, a splitted pin 320, having a conic end, locks locking part 297 of door 230 such as to keep door 230 closed. By grasping key or handle 330, a user may rotate pin 320 counter clockwise and thus release locking part 297 from pin 320, allowing a user to open door 230.

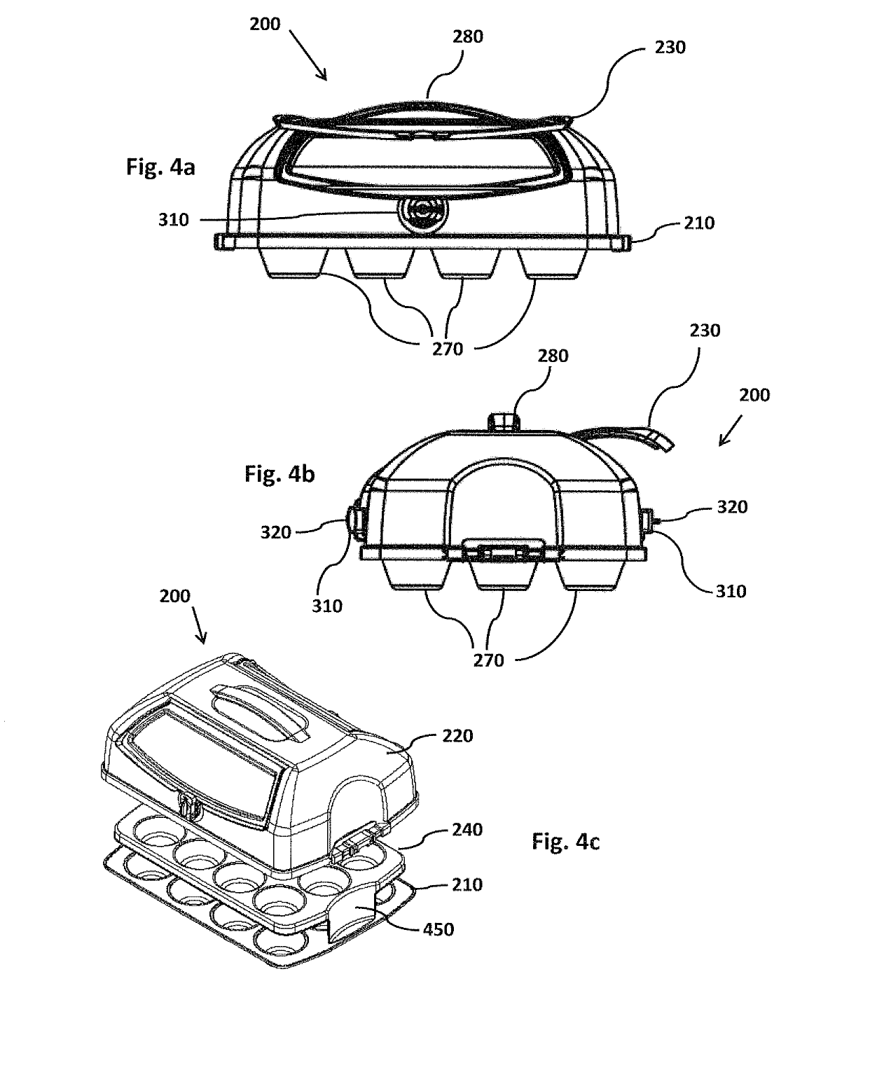

Reference is now made to FIGS. 4a and 4b which present two side views of container 200, showing bottom dish 210 with a plurality of uniform concavities 270 for receiving cupcakes 100. In the shown example, bottom dish 210 has 4×3=12 uniform concavities 270. Alternatively, concavities 270 may be non-uniform such as to allow baking of non-uniform personal cakes.

The side view of FIG. 4b shows key 320 of the right hand side in an opened position of locker 310, while key 320 of the left band side is shown in a closed position of locker 310.

Reference is now made to FIG. 4c which shows an exploding view of oval muffin container 200. Serving muffin dish 240 rests on a baking muffin dish 210 by a leg 450, whereas baking dish 210 is used as a container bottom.

### A Round Container Embodiment

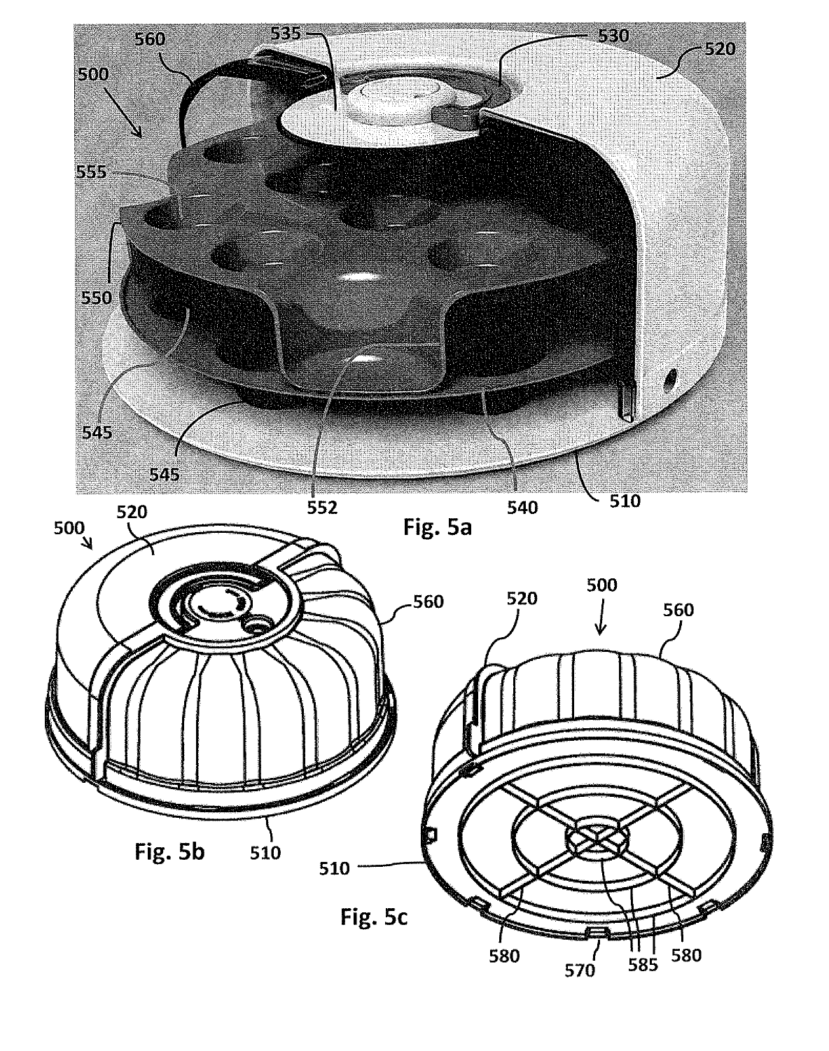

### FIGS. 5-8

A round container 500 is described in FIGS. 5-8. A cover 520 is attached to a bottom 510, such that container 500 may be carried using an handle 530 which is attached to cover 520. In FIG. 5a, handle 530 lays down on a round embedded groove 535 on top of cover 520. A dish 540 having several uniform concavities 545 for receiving cupcakes or muffins 100 is disposed on bottom 510. Another dish 550 is disposed over dish 540 using legs 552. Dish 550 has also several concavities for receiving cupcakes. Concavities 545 of lower dish 540, concavities 555 of dish 550, and legs 552 are aligned such as not to overlap each another and muffins 100.

A rotating door 560 is disposed inside cover 520 and may be rotated between an opened position of FIG. 5a and a closed position of FIG. 5b and FIG. 5c. In the opened position of rotating door 560, part of the cupcakes in the concavities 545 of dishes 540 and 550 are accessible for taking out of container 500. Dish 540 may be rotated easily, in a sliding motion over bottom 510, such as to make the rest of cupcakes 100 also accessible for serving.

Reference is now made to FIG. 5c. It shows a bottom perspective view of container 500. Bottom 510 has six recesses 570 for locking cover 520 to bottom 510, as further elaborated below. It also has a rib configuration which includes rectangular crossed ribs 580 and three concentric round ribs 585. The rib configuration provides thermal insulation between container 500 and an hosting surface.

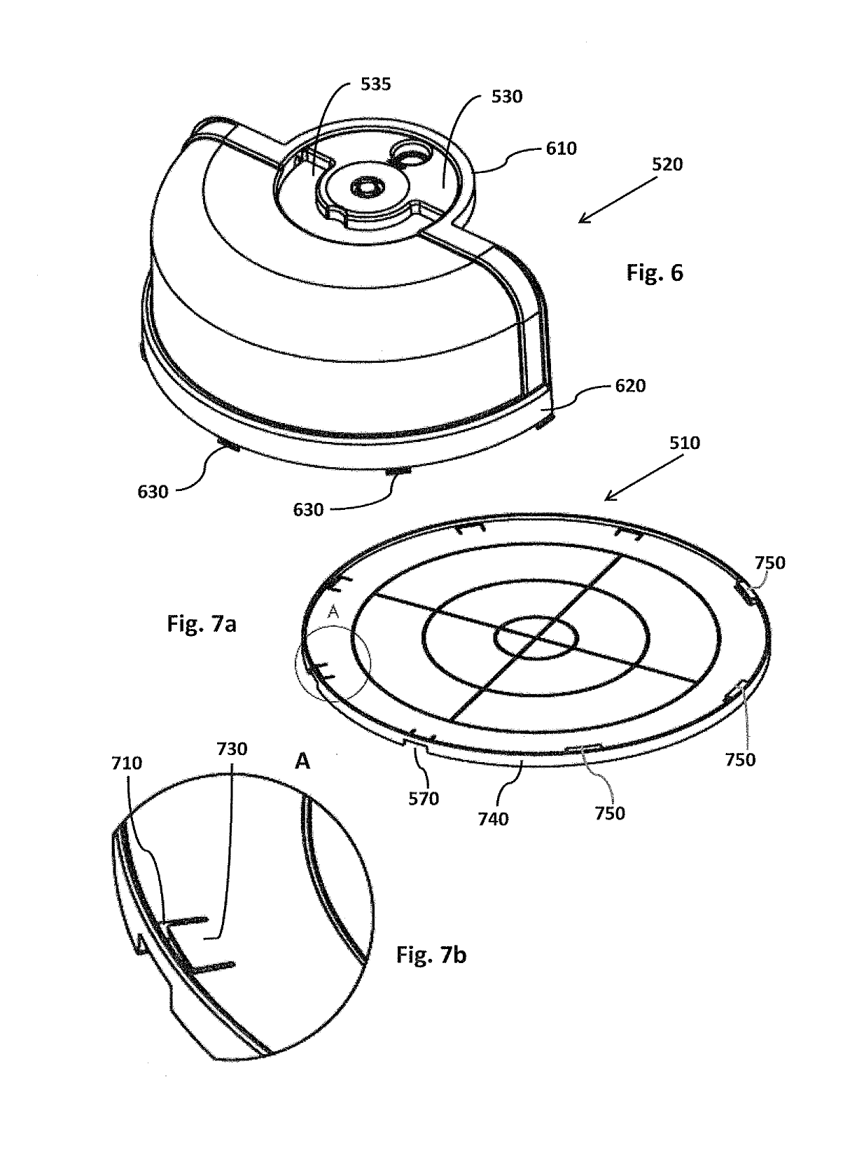

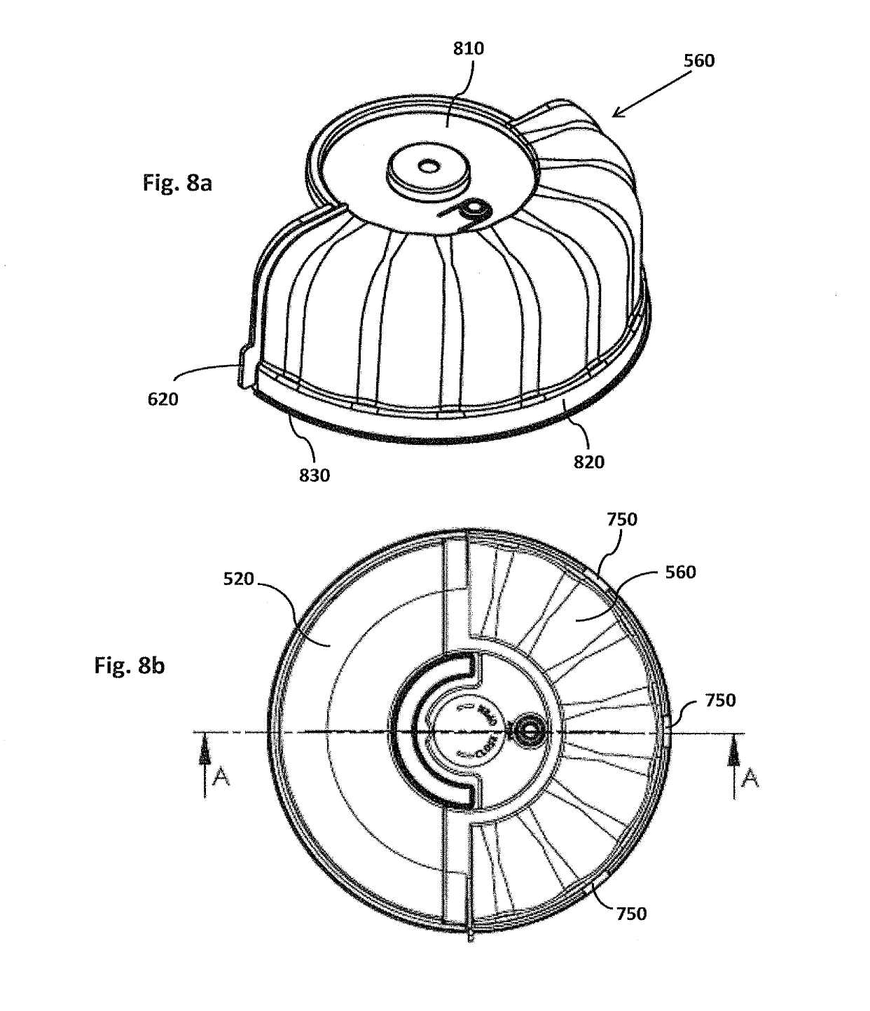

Referring now to FIG. 6, FIG. 7a and inset A of FIG. 7b, cover 520 has a half-circular horizontal cross-section up to its top. The upper horizontal part of cover 520 includes a fully circular part 610 having a circular embedded groove 535 for resting pivotal handle 530. On its lower part, cover 520 has an outwards projected sliding channel 620 for hosting a compatible part of rotating door 560, and several hooks 630 adapted for being locked inside recesses 570. As elaborated below, hooks 630 penetrate bottom 510 through a slot 710 which reside between tabs 730 and a thickened edge 740 of bottom 510. Bottom 510 has also guiding elements 750 for hosting rotating door 560 in a fully or a partial closed position as further illustrated below. For that sake, guiding elements 750 has a L shaped cross-section whereas a vertical side is projected out of bottom 510 and a horizontal side is substantially parallel to bottom 510.

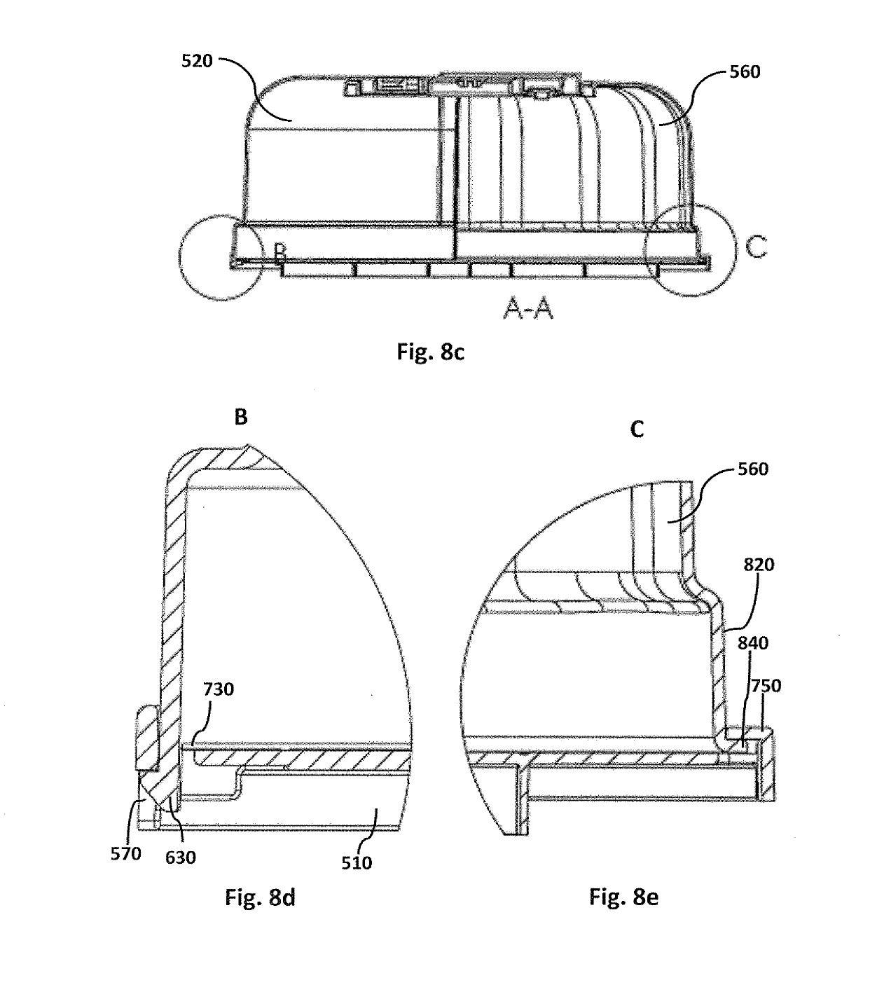

Reference is now made to FIGS. 8a, 8b,8c,8d, and 8e. FIG. 8a shows a perspective view of rotating door 560. In similarity to cover 520, it has a half-circular horizontal cross-section up to its top, but of smaller diameter than that of cover 520, such that a major part of rotating door 560 is embedded within cover 520 in the opened position. On top of door 560 there is a circular structure having a circular embedded groove 810 configured to receive circular embedded groove 535 of cover 520. On the bottom, door 560 has a projected circular channel 820 configured to slide inside sliding channel 620 of cover 520. Door 560 is terminated with a circular foot 840 which slides into guiding elements 750.

FIG. 8b is an upper view of round muffin container 500 in a fully closed position, whereas FIG. 8c is a sectional view of container 500 along section A-A of FIG. 8b. FIG. 8b emphasizes two different engagement details, engagement detail B of cover 520 to bottom 510, and engagement detail C of rotating cover 560 to bottom 510. FIG. 8d is an enlarged sectional view of engagement detail B, showing hook 630 of cover 520 engaged inside recess 570 of bottom 510, whereas tab 730 is deflected downwards by hook 630. FIG. 8e is an enlarged sectional view of engagement detail C circular foot 840 within guiding element 750. Guiding elements 750 may be replaced by continuous channel having the same L cross-section or shaped differently such as to provide the guiding functionality.

Note that the locking mechanism of cover 520 and door 560 to bottom 510 provides sufficient attachment force between these parts, such that carrying container 500 by handle 530 does not cause loss of the carried muffins by departure of cover 520 from bottom 510. For that sake, the locking mechanism is designed to withstand a total weight of dishes 540 and 550, and muffins 100 carried thereof, of at least 1 kg, preferably of at least 1.5 kg, and most preferably of at least 2 kg.

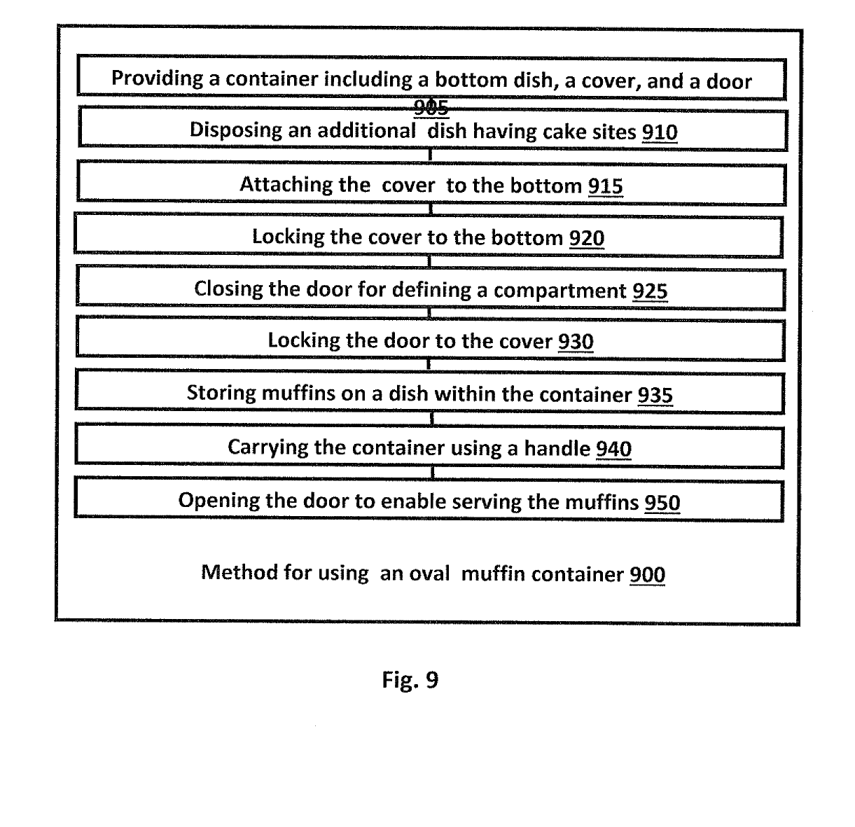

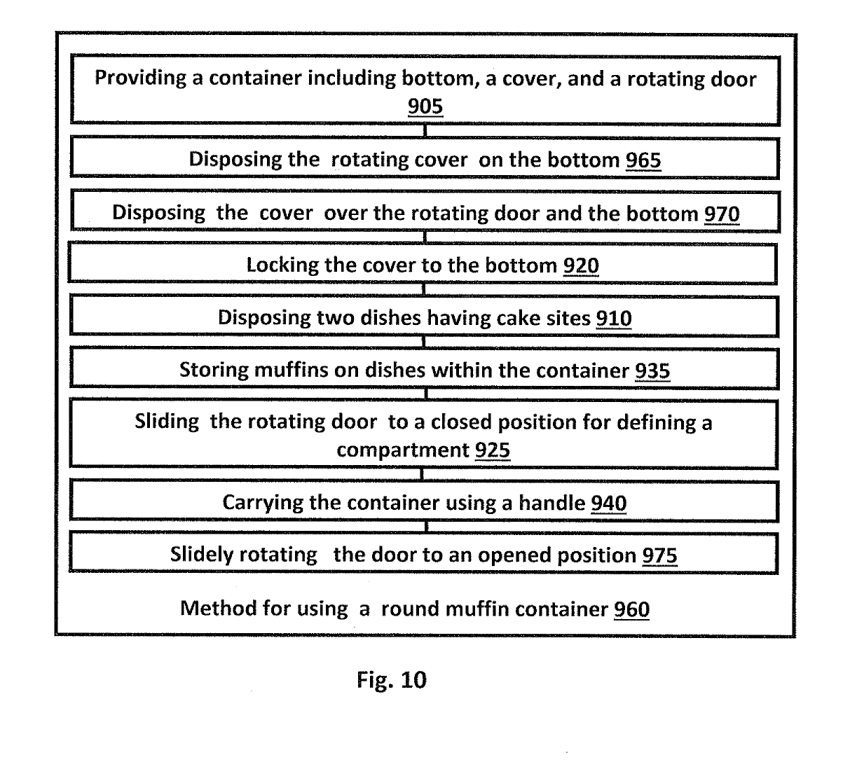

### Methods for Using Muffin Containers (FIGS. 9-10)

The method disclosed below may be performed in any order or simultaneously, unless it is clear from the context that one step depends on another being performed first.

Reference is made to the flow chart of FIG. 9, enlisting steps of a method 900 for assembling and using a container 200 for storing cupcakes or muffins 100 and for serving cupcakes 100. Method 900 includes a step 905 of providing the parts of a container 200, a bottom dish 210, a cover 220 attachable to bottom 210, and doors 230 and 235 connectable to cover 220. Method 900 also includes a step 910 of disposing on bottom 510 a dish 240 having several sites 260 for receiving cupcakes 100, a step 915 of attaching cover 220 to bottom 210, a step 920 of locking cover 220 to bottom 210, a step 925 of closing doors 230 and 235 such as to define with bottom 210 and with cover 220 a sealed compartment for storing muffins 100, a step 930 of locking doors 230 and 235 to cover 220, a step 935 of storing muffins on dish 240, a step 940 of carrying container 200 using an handle 280, and a step 950 of opening doors 230 and 235 such as to enable serving most of the stored cupcakes 100.

FIG. 10 enlists steps of a method 960 for assembling and using a round container 500 for storing cupcakes or muffins 100 and for serving cupcakes 100. Method 960 includes a step 905 of providing the parts of a container 500, a bottom 510, a cover 520 attachable to bottom 510, and rotating door 560 connectable to cover 520. Method 960 also includes a step 965 of disposing the rotating cover on bottom 510, a step 970 of disposing a cover 520 over rotating door 560 and bottom 510, a step 920 of locking cover 520 to bottom 510, a step 910 of disposing two dishes 540 and 550 having cake sites in container 500, a step 935 of storing muffins on dishes 540 and 550, a step 925 of sliding door 560 to a closed position such as to define with bottom 510 and with cover 520 a sealed compartment for storing muffins 100, a step 940 of carrying container 500 using an handle 530, and a step 975 of slidely rotating door 560 such as to enable serving most of the stored cupcakes 100.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. In particular, the present invention is not limited in any way by the examples described.

1. A container for storing cakes and for serving the cakes, the cakes being ready to be served for eating, the container comprising:
(a) a bottom;
(b) a cover attachable to said bottom;
(c) at least one door connected to said cover;
(d) a closed state of said at least one door wherein said at least one door defining with said bottom and with said cover a sealed compartment for storing the cakes in one or more dishes, the dishes being compatible with said sealed compartment and having each a plurality of sites for receiving said cakes; and
(e) at least one opened state of said at least one door wherein at least a major part of the stored cakes being accessible for being taken out of the compartment.

2. The container of claim 1 wherein each of said one or more dishes has a plurality of concavities of substantially uniform shape for receiving the cakes.

3. The container of claim 1 wherein said bottom is a baking dish having a plurality of concavities for shaping cakes in a desired shape.

4. The container of claim 1 wherein at least one dish has at least 6 concavities for receiving cakes.

5. The container of claim 1 wherein the cover includes a handle for carrying the container.

6. The container of claim 1 wherein the container is adapted for storing muffins without substantial drying for a duration of at least three days after baking under room temperature in the range of 0-100° F. and humidity in the range of 25-100%.

7. The container of claim 1 wherein said cover is lockable to said bottom.

8. The container of claim 1 wherein said door is lockable to said cover.

9. The container of claim 1 wherein an horizontal cross-section of the container has a substantially oval boundary.

10. The container of claim 1 wherein said at least one door is pivotally connected to said cover.

11. The container of claim 1 wherein an horizontal cross-section of the container has a substantially circular boundary.

12. The container of claim 1 wherein said at least one door is slidably connected to said cover.

13. A method for assembling and using a container for storing cakes and for serving the cakes, the cakes being ready to be served for eating, the method comprising:
(a) providing a container including:
(i) a bottom;
(ii) a cover attachable to said bottom; and
(iii) at least one door connectable to said cover;
(b) disposing on said bottom at least one dish having a plurality of sites for receiving cakes;
(c) attaching said cover to said bottom;
(d) closing said at least one door such that said at least one door defining with said bottom and with said cover a sealed compartment for storing the cakes; and
(e) opening said at least one door such as to enable serving at least a major part of the stored cakes.

14. The method of claim 13 wherein the method further includes a step of locking said cover to said bottom.

15. The method of claim 13 wherein the method further includes a step of locking said at least one door to said cover.

16. The method of claim 13 wherein the method further includes a step of storing muffins in said at least one dish.

17. The method of claim 13 wherein the method further includes a step of carrying the container using a handle.

18. The method of claim 13 wherein the method includes a step of sliding said at least one door.

19. The method of claim 13 wherein the method includes a step of connecting said at least one door to the bottom.
